(19) United States
(12) Patent Application Publication
(10) Pub. No.: US 2019/0162295 A1
(43) Pub. Date: May 30, 2019

(54) SHIFT CONTROL DEVICE FOR VEHICLE

(71) Applicants: Hyundai Motor Company, Seoul (KR); Kia Motors Corporation, Seoul (KR)

(72) Inventors: Vinay Babu, Hyderabad (IN); Han Gil Park, Suwon-si (KR)

(73) Assignees: Hyundai Motor Company, Seoul (KR); Kia Motors Corporation, Seoul (KR)

(21) Appl. No.: 15/890,173

(22) Filed: Feb. 6, 2018

(30) Foreign Application Priority Data
Nov. 29, 2017 (IN) 201711042882

(51) Int. Cl. F16H 59/10; F16H 59/02; G05G 1/015; G05G 1/12

(52) U.S. Cl. CPC F16H 59/10; F16H 59/0278; F16H 2059/0282; G05G 1/12; G05G 1/015

(57) ABSTRACT

A shift control device configured for a vehicle may include a base housing including an open top surface, at least one printed circuit board (PCB) electrically connected to a transmission control unit (TCU) in an internal space, and mounted inside the vehicle; a first actuating portion selectively assembled with an upper portion of the base housing, and including an actuating lever; and a second actuating portion assembled with the upper portion of the base housing, and including an actuating dial, wherein the first actuating portion and the second actuating portion are selectively assembled with the base housing according to selection of a user.

### CROSS-REFERENCE(S) TO RELATED APPLICATIONS

The present application claims priority to Indian Patent Application No. 201711042882 filed on Nov. 29, 2017, the entire contents of which are incorporated herein for all purposes by the present reference.

### BACKGROUND OF THE INVENTION

### Field of the Invention

The present invention relates to a shift control device for a vehicle. More particularly, the present invention relates to a shift control device for a vehicle configured for easily changing to a lever type or a dial type according to a request or selection of a user.

### Description of Related Art

In general, a transmission for converting power of an engine into a suitable driving torque is disposed in a vehicle. The transmission is classified into a manual transmission, an automatic transmission, and a continuously variable transmission (CVT) according to an operation scheme.

A shift control device of an automatic transmission is located inside the vehicle, and is configured as an electronic type to transfer a shift signal generated by a driver to a transmission control unit (TCU).

The transmission control device may transmit a signal to a transmission according to a transferred shift signal to change a shift stage.

A shift control device according to the related art is classified as a lever type to actuate a shift state in an automatic mode and a manual mode by actuating a shift lever forward and rearward and a dial type to control a shift stage by a rotation of a dial.

The lever type of shift control device or the dial type of shift control device is modularized and is manufactured as one shift control device, and is applied as a selection specification when a user buys a vehicle.

That is, the lever type or dial type of modularized shift control device selected by the user is mounted according to a selected specification from an assembly line upon manufacturing the vehicle.

However, the above shift control device according to the related art may selectively apply the lever type or the dial type when the vehicle is manufactured according to the specification selected by the user. However, after the manufacturing the vehicle is finished so that the user buys the vehicle, it is difficult to change the type according to user requirements.

Furthermore, if a shift control device is changed according to user requirements in a vehicle in which the shift control device is mounted, a replacement cost of the shift control device is significantly increased, operating time and operating capacity according to a replacement operation are increased.

Furthermore, since it is difficult to satisfy requirements of a user with respect to change in a shift control device, overall productivity of a vehicle deteriorates.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a shift control device configured for a vehicle having advantages of improving overall productivity of the vehicle by satisfying requirements of a user by easily changing a lever type of actuating portion or a dial type of actuating portion according to the requirements or selection of a user.

Various aspects of the present invention are directed to providing a shift control device configured for a vehicle, including: a base housing including an open top surface, at least one printed circuit board (PCB) electrically connected to a transmission control unit (TCU) in an internal space, and mounted inside the vehicle; a first actuating portion selectively assembled with an upper portion of the base housing, and including an actuating lever; and a second actuating portion assembled with the upper portion of the base housing, and including an actuating dial, wherein the first actuating portion and the second actuating portion are selectively assembled with the base housing according to selection of a user. The first actuating portion may include: a first cover housing including an open bottom surface corresponding to the open top surface of the base housing to be formed therein with a first mount space, and mounted at the upper portion of the base housing; first fixed blocks mounted at both sides of the first mount space in a width direction of the vehicle, respectively; hinge blocks hingedly connected to the first fixed blocks, respectively, and rotatably mounted forward and rearward of the vehicle inside the first cover housing; an actuating shaft mounted through the hinge block, upper and lower portions of the actuating shaft protruding from the first cover housing, respectively, and the actuating lever being mounted at a top end portion of the actuating shaft; and a first magnet member provided at an internal bottom end portion of the actuating shaft protruding downwardly from the first cover housing, to generate a magnetic field between the PCBs to detect a position of the actuating shaft.

The first cover housing may be detachably assembled at the upper portion of the base housing through an assembly bolt.

Hinge shafts may protrude to both sides of the hinge blocks based on a width direction of the vehicle corresponding the first fixed blocks, respectively.

The actuating shaft may be mounted perpendicular to the hinge shaft through a center of the hinge block.

A slot may be formed at a top surface of the first cover housing of the first cover housing so that the actuating shaft performs forward and rearward movements in a state that an upper portion of the actuating shaft protrudes.

The second actuating portion may include: a first cover housing including an open bottom surface corresponding to the open top surface of the base housing to be formed therein with a second mount space, and mounted at the upper portion of the base housing, and the actuating dial is rotatably mounted at first cover housing; second fixed blocks mounted at both sides of the second mount space in a width direction of the vehicle, respectively; hinge shafts including both sides hingedly connected to the second fixed blocks, respectively; a gear rod formed at a lower portion of the actuating dial to be inserted into the second mount space, and an actuating gear being integrally formed with an end portion of the gear rod; a protrusion integrally protruding upwards from the hinge shaft, and a driven gear train engaged with the actuating gear being integrally formed on one surface of the protrusion toward the gear rod; a connection shaft integrally extending downwardly from the hinge shaft to protrude to a lower portion of the second cover housing; and a second magnet member provided at an internal lower side of the connection shaft, to generate a magnetic field between the PCBs to detect a position of the connection shaft.

The protrusion may selectively rotate the hinge shaft forward or rearward of the vehicle according to a rotating direction of the actuating gear engaged with the driven gear train when the actuating dial is rotated.

The connection shaft may be formed perpendicular to the hinge shaft, and is moved forward or rearward of the vehicle according to a rotating direction of the hinge shaft.

The second cover housing is detachably assembled with the upper portion of the base housing through an assembly bolt.

The PCBs may be provided at both sides inside the space in a width direction of the vehicle, respectively.

As described above, in the shift control device configured for a vehicle according to an exemplary embodiment of the present invention, overall productivity of the vehicle may be improved by satisfying requirements of a user by easily changing a lever type of actuating portion or a dial type of actuating portion according to the requirements or selection of a user.

Furthermore, if a shift control device is changed according to user requirements in a vehicle in which the shift control device is mounted, since only an actuating portion may be changed, a replacement cost of the shift control device is reduced, and operating time and operating capacity according to a replacement operation are reduced.

Furthermore, after manufacturing of the vehicle is finished and the user buys the vehicle, the actuating portion may be easily changed according to requirements of the user.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram illustrating a configuration of a shift control device configured for a vehicle according to an exemplary embodiment of the present invention.

FIG. 2 is an exploded perspective view illustrating a shift control device configured for a vehicle according to an exemplary embodiment of the present invention.

FIG. 3 is a projection perspective view illustrating a first actuating portion applied to a shift control device configured for a vehicle according to an exemplary embodiment of the present invention.

FIG. 4 is a cross-sectional view illustrating a lever type of first actuating portion applied to a shift control device configured for a vehicle according to an exemplary embodiment of the present invention.

FIG. 5 is an operating state diagram illustrating a first actuating portion applied to a shift control device configured for a vehicle according to an exemplary embodiment of the present invention.

FIG. 6 is a projection perspective view illustrating a second actuating portion applied to a shift control device configured for a vehicle according to an exemplary embodiment of the present invention.

FIG. 7 is a cross-sectional view illustrating a lever type of second actuating portion applied to a shift control device configured for a vehicle according to an exemplary embodiment of the present invention.

FIG. 8, FIG. 9 and FIG. 10 are operating state diagrams illustrating a second actuating portion applied to a shift control device configured for a vehicle according to an exemplary embodiment of the present invention.

It may be understood that the appended drawings are not necessarily to scale, presenting a somewhat simplified representation of various features illustrative of the basic principles of the invention. The specific design features of the present invention as included herein, including, for example, specific dimensions, orientations, locations, and the shapes will be determined in part by the particularly intended application and use environment.

In the figures, reference numbers refer to the same or equivalent parts of the present invention throughout the several figures of the drawing.

### DETAILED DESCRIPTION

Reference will now be made more specifically to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the other hand, the invention(s) is/are intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described more specifically with reference to the accompanying drawings.

Although embodiments have been described with reference to a number of illustrative embodiments thereof, it may be understood that numerous other modifications and embodiments can be devised by those skilled in the art that will fall within the spirit and scope of the principles of the present invention.

The drawings and description are to be regarded as illustrative in nature and not restrictive. Like reference numerals designate like elements throughout the specification.

Since the size and the thickness of each configuration shown in drawings are arbitrarily indicated for better understanding and ease of description, the present invention is not limited to shown drawings, and the thickness of layers, films, panels, regions, etc., are exaggerated for clarity.

In the full specification, unless explicitly described to the contrary, the word “comprise” and variations such as “comprises” or “comprising” will be understood to imply the inclusion of stated elements but not the exclusion of any other elements.

Furthermore, terms such as “ . . . unit”, “.means”, “ . . . unit”, and “ . . . member” described in the specification signifies a unit of a collective configuration to perform at least one function or operation.

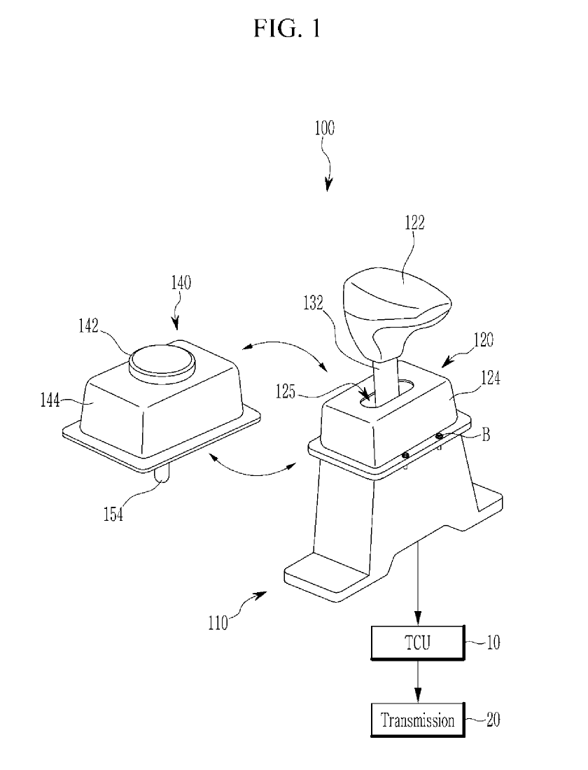

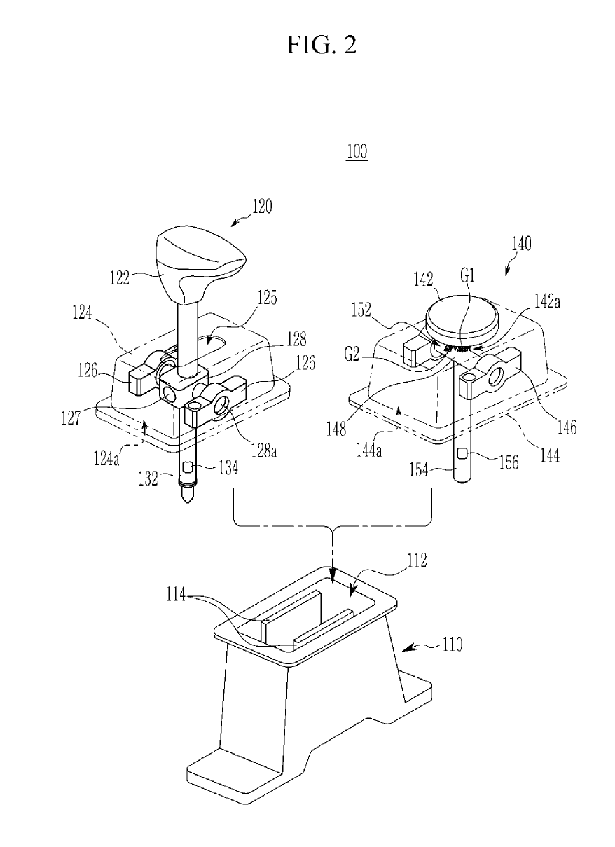

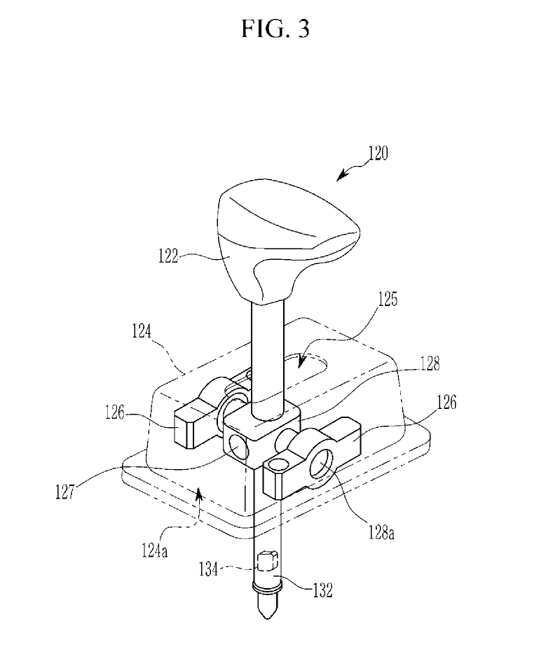

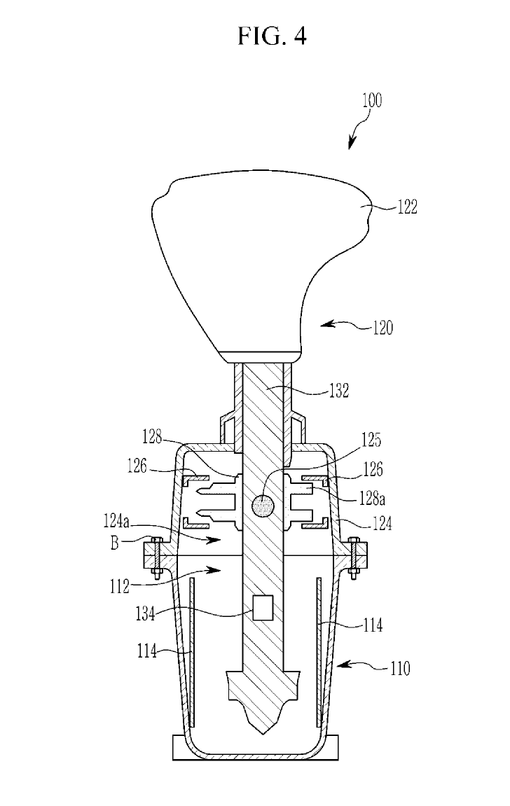

FIG. 1 is a schematic diagram illustrating a configuration of a shift control device configured for a vehicle according to an exemplary embodiment of the present invention, FIG. 2 is an exploded perspective view illustrating a shift control device configured for a vehicle according to an exemplary embodiment of the present invention, FIG. 3 is a projection perspective view illustrating a first actuating portion applied to a shift control device configured for a vehicle according to an exemplary embodiment of the present invention, and FIG. 4 is a cross-sectional view illustrating a lever type of first actuating portion applied to a shift control device configured for a vehicle according to an exemplary embodiment of the present invention.

Referring FIG. 1 and FIG. 2, the shift control device 100 for a vehicle according to an exemplary embodiment of the present invention is mounted inside the vehicle, and controls a shift stage by operation of a user.

The shift control device 100 is electrically connected to a transmission control device 10, and outputs a shift stage signal according to the operation of the user. Furthermore, the transmission control device 10 outputs a control signal to a transmission 20 according to a signal output from the shift control device so that a shift is performed.

The transmission 20 may perform an automatic shift mode including park P, reverse (R), neutral (N), and drive (D), and a manual shift mode (sports mode) according to a control signal output from the transmission control device 10, respectively.

In the instant case, the shift control device 100 according to an exemplary embodiment of the present invention includes a base housing 100, a first actuating portion 120, and a second actuating portion 140. The first actuating portion 120 and the second actuating portion 140 may be selectively assembled with the base housing 110 according to selection of a user.

First, a top surface of the base housing 100 is open, and the base housing 100 may include a substantially square-shaped box and may be formed therein with a space 112.

At least one printed circuit board (PCB) 114 electrically connected to the transmission control device 10 is provided in the space 112, and is mounted inside the vehicle.

In the instant case, the PCBs 114 may be provided at both sides in a width direction of the vehicle inside the space 112. The PCB 114 may include a detector which is not shown.

The first actuating portion 120 is selectively assembled with an upper portion of the base housing 110, and may include an actuating lever 122.

In the instant case, the first actuating portion 120, as shown in FIG. 3 and FIG. 4, includes a first cover housing 124, a first fixed block 126, a hinge block 128, an actuating shaft 132, and a first magnet member 134.

First, the first cover housing 124 may include a substantially square-shaped box corresponding to the base housing 110. A bottom surface of the first cover housing 124 is open corresponding to the open top surface of the base housing 110, and is formed therein with a first mount space 124a.

The first cover housing 124 configured as above is mounted at an upper portion of the base housing 110.

In the instant case, the first cover housing 124 may be detachably assembled with an upper portion of the base housing 110 through an assembling bolt B.

The first fixed blocks 126 are mounted at both sides of the first mount space 124a in a width direction of the vehicle, respectively.

The hinge block 128 is hingedly connected to each first fixed block 126, and may be rotatably mounted inside the first cover housing 124 forward and rearward of the vehicle.

In the instant case, hinge shafts 128a may protrude in both sides of the hinge block 128 based on a width direction of the vehicle corresponding to the first fixed block 126, respectively.

That is, each hinge shaft 128a is hingedly connected to the first fixed block 126 so that the hinge block 128 is rotated in forward and reverse directions of the vehicle.

In the instant case, the hinge block 128 may be positioned on the fixed block 126 through a separate fixing member including a torsion spring.

In the exemplary embodiment of the present invention, the actuating shaft 132 is mounted through the hinge block 128, and upper and lower portions of the actuating shaft 132 protrude above and below the first cover housing 124, respectively.

In the instant case, the actuating shaft 132 may be mounted perpendicular to the hinge shaft 128a through a center of the hinge block 128 based on a vertical direction of the vehicle.

Furthermore, the actuating shaft 132 may be fixed to the hinge block 128 through a fixing pin 127 through the hinge block 128.

Furthermore, the actuating lever 122 may be mounted to a top end portion of the actuation shaft 132 protruding to an upper portion of the first cover housing 124.

That is, if the user moves the actuating lever 122 forward or rearward of the vehicle while holding the actuating lever 122, the actuating shaft 132 in which the actuating lever 122 is mounted may be easily moved forward or rearward of the vehicle through the hinge block 128 hingedly connected to the fixed block 126.

Meanwhile, a slot 125 may be formed in a top surface of the first cover housing 124 so that the actuating shaft 132 performs forward and rearward movements in a state that an upper portion of the actuating shaft 132 protrudes.

Furthermore, the first magnet member 134 is provided at an internal bottom end portion of the actuating shaft 132 protruding from a lower portion of the first cover housing 124.

The above first magnet member 134 may generate a magnetic field between the PCBs 114 to detect a position of the actuating shaft 132.

Accordingly, if a position of the actuating shaft 132 is moved forward or rearward of the vehicle, a position of the first magnet member 134 is changed together therewith. In the instant case, a detector included in the PCB 114 detects variation in a magnetic flux density generated when the first magnetic member 134 is moved.

That is, the changed position of the actuating shaft 132 may be known through a detector configured for detecting variation in the magnetic flux density generated when the first magnet member 134 generating the magnetic field is moved.

The detectors are disposed in parts of the PCB 114 to which the actuating shaft 132 rotates, and may detect a rotation position of the actuating shaft 132.

The detector is electrically connected to the transmission control device 10, and may detect a position of the actuating shaft 132 to output a detection signal to the transmission control device 10.

In the instant case, the detector may include a Hall detector. The Hall detector is a type of detector used to recognize a direction and the size of a magnetic field using a Hall effect where a voltage is vertically generated in a current and a magnetic field when the magnetic field is applied to a conductor through which the current flows. The Hall detector is well-known in the art, and thus the detailed description of an operation and a function thereof is omitted.

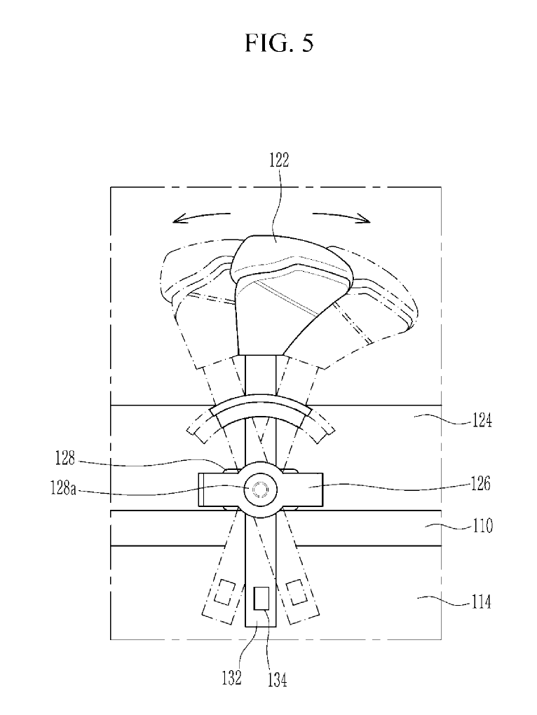

An operation of the first actuating portion 120 configured as above mounted at the base housing 110 will be described more specifically with reference to FIG. 5.

FIG. 5 is an operating state diagram illustrating a first actuating portion applied to a shift control device configured for a vehicle according to an exemplary embodiment of the present invention.

Referring to FIG. 5, in a state that starting of the vehicle is turned-ON, when a shift stage is in a neutral state, the actuating lever 122 maintains an initial mount state.

That is, the actuating shaft 132 is located at a center inside the space 112 in a vertical direction of the hinge shaft 128a, and the first magnet member 134 is also located at the center.

Accordingly, the detector included in the PCB 114 detects a magnetic field generated from the first magnet member 134 to output a corresponding detection signal to the shift control device 10. The shift control device 10 determines that the actuating shaft 132 is located at a center in a space 112 of the base housing 110 through the output signal, and outputs a control signal so that the transmission 20 maintains a neutral state.

In the present state, if the user moves the actuating lever 122 forward of the vehicle, a lower portion of the actuating shaft 122 moves rearward of the vehicle based on the hinge shaft 128a, and simultaneously, the first magnet member 134 is moved rearward of the vehicle.

In the instant case, a detector included in the PCB 114 detects a position of the actuating shaft 132 by detecting variation in a magnetic flux density generated when the first magnet member 134 is moved to output a corresponding detection signal to the shift control device 10.

The shift control device 10 determines that the actuating shaft 132 is moved rearward of the vehicle in a space 112 of the base housing 110 through the output signal, and outputs a control signal to the transmission 20 to perform reverse shifting.

Conversely, if the user moves the actuating lever 122 rearward of the vehicle, a lower portion of the actuating shaft 122 is moved forward of the vehicle based on the hinge shat 128a, and simultaneously, the first magnet member 134 is moved forward of the vehicle.

In the instant case, a detector included in the PCB 114 detects a position of the actuating shaft 132 by detecting variation in the magnetic density generated when the first magnet member 134 is moved, and outputs a corresponding detection signal to the shift control device 10.

The shift control device 10 determines that the actuating shaft 132 is moved forward of the vehicle in a space 112 of the base housing 110 through an output signal, and outputs a control signal to the transmission 20 so that drive shifting is performed.

Meanwhile, in a shift control device configured for a vehicle according to an exemplary embodiment of the present invention, a configuration of a second actuating portion 140 selectively assembled with an upper portion of the base housing 110, and including an actuating dial 142, is described.

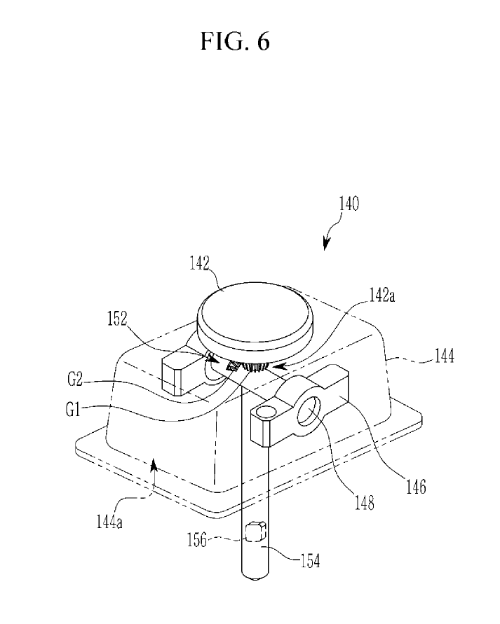

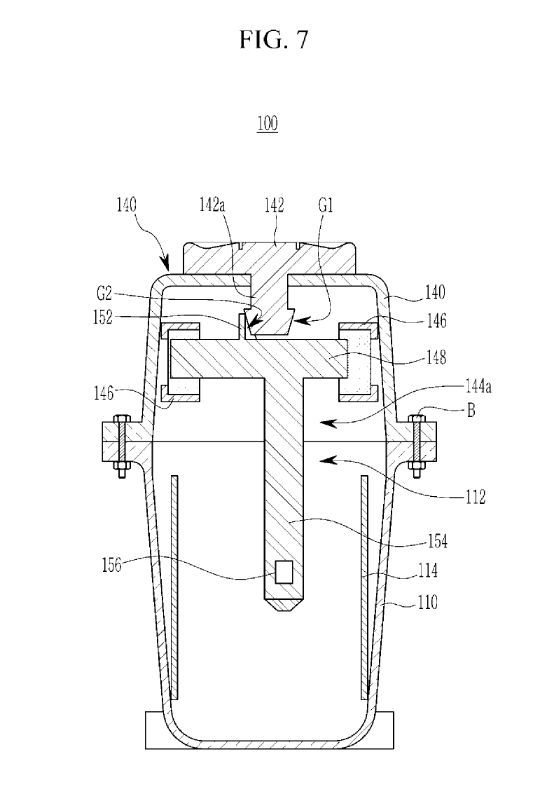

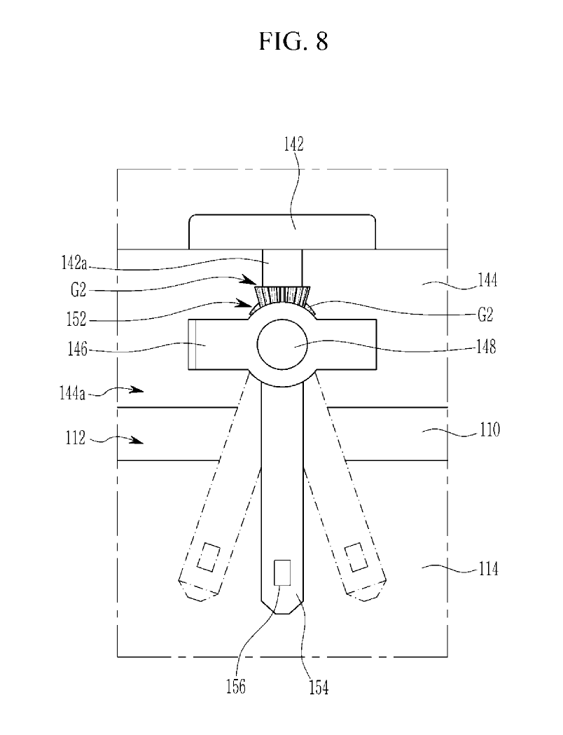

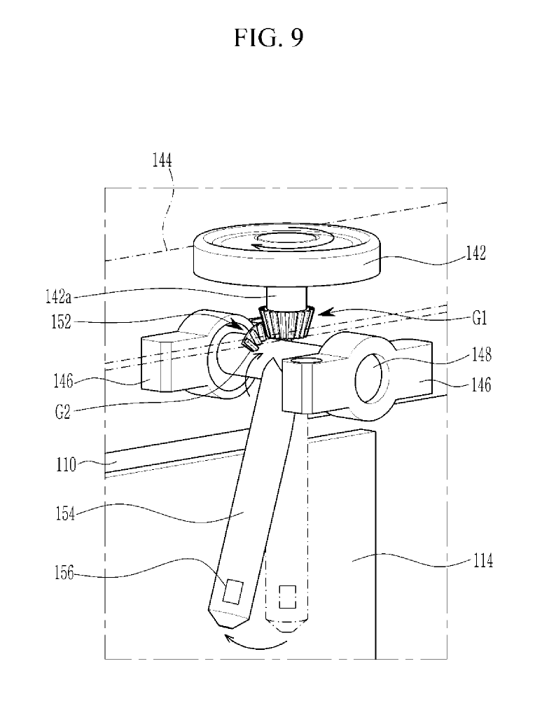

FIG. 6 is a projection perspective view illustrating a second actuating portion applied to a shift control device configured for a vehicle according to an exemplary embodiment of the present invention, and FIG. 7 is a cross-sectional view illustrating a lever type of second actuating portion applied to a shift control device configured for a vehicle according to an exemplary embodiment of the present invention.

Referring to FIG. 6 and FIG. 7, in the shift control device according to an exemplary embodiment of the present invention, the second actuating portion 140 includes a second cover housing 144, a second fixed block 146, a hinge shaft 148, a gear rod 142a, a protrusion 152, a connection shaft 154, and a second magnet member 152.

First, the second cover housing 144 may include a substantially square-shaped box corresponding to the base housing 110. A bottom surface of the second cover housing 144 is open corresponding to an open top surface of the base housing 110, and is formed therein with a second mount space 144a.

Furthermore, the actuating dial 142 may be rotatably mounted at a top surface of the second cover housing 144.

The second cover housing 144 configured as above is mounted at an upper portion of the base housing 110.

In the instant case, the first cover housing 124 may be detachably assembled with an upper portion of the base housing 110 through an assembly bolt B.

The second fixed blocks 146 are mounted in both sides of the second mount space 144a in a width direction of the vehicle, respectively.

In the exemplary embodiment of the present invention, both sides of the hinge shaft 148 are hingedly connected to the second fixed block 126, respectively, and may be rotatably mounted forward and rearward of the vehicle inside the second cover housing 144.

The gear rod 142a is formed at a lower portion of the actuating dial 142 and is inserted into the second mount space 144a, and an actuating gear G1 is integrally formed with an end portion of the gear rod 142a.

The protrusion 152 integrally protrudes upward from the hinge shaft 148. A driven gear train G2 is engaged with the actuating gear G1 at one surface toward the gear rod 142 in the protrusion 152.

Moreover, the protrusion 152 may be formed to have a circular sector in a predetermined section in a circumferential direction of the hinge shaft 148.

Accordingly, the protrusion 152 is engaged with the actuating gear G1 of the gear rod 142a through the driven gear train G2. Accordingly, when the user rotates the actuating dial 142, the protrusion 152 rotates the hinge shaft 148 forward or rearward of the vehicle.

That is, if the actuating dial 142 is rotated, the protrusion 152 may selectively rotate the hinge shaft 148 forward or rearward of the vehicle in a rotating direction of the actuating gear G1 engaged with the driven gear train G2.

In the exemplary embodiment of the present invention, the connection shaft 154 integrally extends downwardly from the hinge shaft 148 and protrudes downward of the second cover housing 144.

In the instant case, the connection shaft 154 may be mounted perpendicular to the hinge shaft 148 based on a height direction of the vehicle.

The connection shaft 154 may be moved forward or rearward of the vehicle while being inserted into a space 112 of the base housing 110 in a rotating direction of the hinge shaft 148.

Furthermore, the second magnet member 156 is provided at an internal bottom end portion of the connection shaft 154 which protrudes downwardly from the second cover housing 144.

The second magnet member 156 may generate a magnetic field between the PCBs 114 to detect a position of the connection shaft 156.

Accordingly, if a position of the connection shaft 154 is moved forward or rearward of the vehicle by selective rotation of the hinge shaft 148, a position of the second magnet member 156 is changed together therewith. In the instant case, a detector included in the PCB 114 detects variation in a magnetic flux density generated when the second magnet member 156.

That is, the changed position of the connection shaft 154 may be known by a detector configured for detecting variation in a magnetic flux density generated when the second magnet member 156 for generating a magnetic field is moved.

The detectors are disposed at parts of the PCB 114 to which the connection shaft 154 is rotated, respectively, and may detect a rotation position of the connection shaft 154.

The detector may be electrically connected to the transmission control device 10, and may detect the connection shaft 154 to output a corresponding detection signal to the transmission control device 10.

In the instant case, the detector may include a Hall detector. The Hall detector is a type of detector to recognize a direction and the size of a magnetic field using a Hall effect where a voltage is vertically generated in a current and a magnetic field when the magnetic field is applied to a conductor through which the current flows. The Hall detector is well-known in the art, and thus the detailed description of an operation and a function thereof.

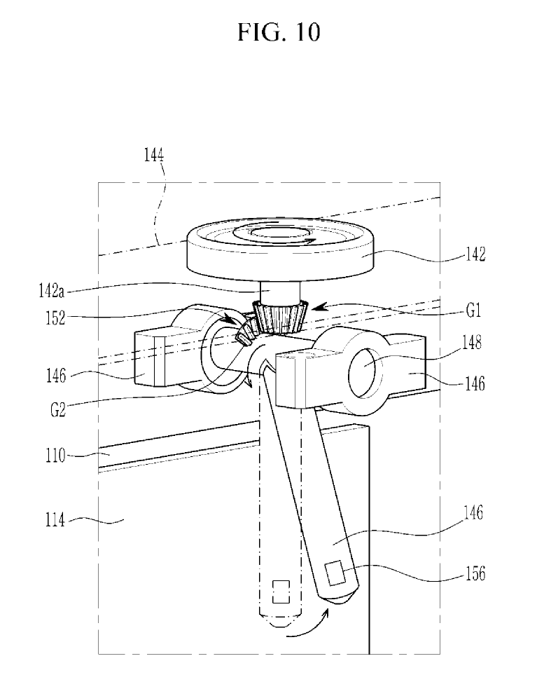

An operation of the second actuating portion 140 configured as above mounted at the base housing 110 will be described more specifically with reference to FIG. 8 to FIG. 10.

FIG. 8, FIG. 9 and FIG. 10 are operating state diagrams illustrating a second actuating portion applied to a shift control device configured for a vehicle according to an exemplary embodiment of the present invention.

Referring to FIG. 8, in a state that starting of the vehicle is turned-ON, when a shift stage is in a neutral state, a user does not rotate the actuating dial 142 to maintain an initial state of the actuating dial 142.

Accordingly, the connection shaft 154 is located at a center inside the space 112 perpendicular to the hinge shaft 148, so that the second magnet member 156 is also located at the center.

Accordingly, a detector included in the PCB 114 detects a magnetic field generated from the second magnet member 156 to output a corresponding detection signal to the shift control device 10. The shift control device 10 determines that the connection shaft 154 is located at a center in a space 112 of the base housing 110 through the output signal, and outputs a control signal to the transmission 20 so that the transmission 20 maintains a neutral state.

In the present state, as shown in FIG. 8 and FIG. 9, if the user turns the actuating dial 142 clockwise, the gear rod 142a is turned clockwise together therewith.

Accordingly, the hinge shaft 148 is rotated forward of the vehicle by a driven gear train G2 of the protrusion 152 engaged with the actuating gear G1, and simultaneously, a lower portion of the connection shaft 154 is moved rearward of the vehicle based on the hinge shaft 148.

Accordingly, the second magnet member 156 is moved rearward of the vehicle by the connection shaft 154.

In the instant case, the detector included in the PCB 114 detects a position of the connection shaft 154 by detecting variation in the magnetic flux density generated when the second magnet member 156 is moved to output a corresponding detection signal to the shift control device 10.

The shift control device 10 determines that the connection shaft 154 is moved rearward of the vehicle in a space of the base housing 110 through the output signal to output a control signal to the transmission 20 so that the transmission performs a reverse shifting operation.

Conversely, as shown in FIG. 8 and FIG. 10, if the user turns the actuating 142 counterclockwise, the gear rod 142a is turned counterclockwise together therewith.

Accordingly, the hinge shaft 148 is rotated rearward of the vehicle by a driven gear train G2 of the protrusion 152 engaged with the actuating gear G1, and simultaneously, a lower portion of the connection shaft 154 is moved forward of the vehicle based on the hinge shaft 148.

Accordingly, the second magnet member 156 is moved forward of the vehicle by the connection shaft 154.

In the instant case, a detector included in the PCB 114 detects a position of the connection shaft 154 by detecting variation in a magnetic flux density generated when the second magnet member 156 is moved to output a corresponding detection signal to the shift control device 10.

The shift control device 10 determines that the connection shaft 154 is moved forward of the vehicle in a space 112 of the base housing 110 through an output signal, and outputs a control signal to the transmission 20 so that drive shifting is performed.

That is, the shift control device 10 according to an exemplary embodiment of the present invention may use the base housing 100 including the PCB 114 electrically connected to the shift control device 10 in common, and may use a lever type of first actuating portion 120 or a dial type of second actuating portion 140 in common.

Accordingly, when the shift control device 10 for a vehicle according to an exemplary embodiment of the present invention configured as above is applied, the overall productivity of the vehicle may be improved by satisfying a request of a user by easily changing a lever type or dial type of first and second actuating parts 120 and 140 according to requirements or selection of the user.

Furthermore, when an actuating portion is changed to a lever type of first actuating portion 120 or a dial type of the second actuating portion 140 according to requirements of the user in a vehicle in which the shift control device is mounted, since only the lever type of first actuating portion 120 or the dial type of second actuating portion 140 from the base housing 110 may be changed, replacement cost may be reduced, and operating time and operating capacity according to a replacement operation may be reduced.

Furthermore, after manufacturing of the vehicle is finished and the user buys the vehicle, the first and second actuating parts 120 and 140 may be easily changed according to requirements of the user.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A shift control device configured for a vehicle, including:
a base housing including an open top surface, at least one printed circuit board (PCB) electrically connected to a transmission control unit (TCU) in an internal space, and mounted inside the vehicle;
a first actuating portion selectively assembled with an upper portion of the base housing, and including an actuating lever; and
a second actuating portion assembled with the upper portion of the base housing, and including an actuating dial,
wherein the first actuating portion and the second actuating portion are selectively assembled with the base housing according to selection of a user.

2. The shift control device of claim 1, wherein
the first actuating portion includes:
a first cover housing including an open bottom surface corresponding to the open top surface of the base housing to be formed therein with a first mount space, and mounted at the upper portion of the base housing;
first fixed blocks mounted at a first side and a second side of the first mount space in a width direction of the vehicle, respectively;
hinge blocks pivotally connected to the first fixed blocks, respectively, and rotatably mounted forward and rearward of the vehicle inside the first cover housing;
an actuating shaft mounted through the hinge blocks, upper and lower portions of the actuating shaft protruding from the first cover housing, respectively, and the actuating lever being mounted at a top end portion of the actuating shaft; and
a first magnet member provided at an internal bottom end portion of the actuating shaft protruding downwardly from the first cover housing, to generate a magnetic field between the at least one PCB to detect a position of the actuating shaft.

3. The shift control device of claim 2, wherein the first cover housing is detachably assembled at the upper portion of the base housing through an assembly fastener.

4. The shift control device of claim 2, wherein hinge shafts protrude to a first side and a second side of the hinge blocks based on a width direction of the vehicle corresponding the first fixed blocks, respectively.

5. The shift control device of claim 4, wherein the actuating shaft is mounted perpendicular to the hinge shaft through a center of the hinge block.

6. The shift control device of claim 2, wherein a slot is formed at a top surface of the first cover housing of the first cover housing so that the actuating shaft performs forward and rearward movements in a state that an upper portion of the actuating shaft protrudes.

7. The shift control device of claim 1, wherein
the second actuating portion includes:
a first cover housing including an open bottom surface corresponding to the open top surface of the base housing to be formed therein with a second mount space, and mounted at the upper portion of the base housing, and the actuating dial is rotatably mounted at a first cover housing;
second fixed blocks mounted at a first side and a second side of the second mount space in a width direction of the vehicle, respectively;
hinge shafts including a first side and a second side pivotally connected to the second fixed blocks, respectively;
a gear rod formed at a lower portion of the actuating dial to be inserted into the second mount space, and an actuating gear being integrally formed with an end portion of the gear rod;
a protrusion integrally protruding upwards from the hinge shaft, and a driven gear train engaged with the actuating gear being integrally formed on a first surface of the protrusion toward the gear rod;
a connection shaft integrally extending downwardly from the hinge shaft to protrude to a lower portion of the second cover housing; and
a second magnet member provided at an internal lower side of the connection shaft, to generate a magnetic field between the at least one PCB to detect a position of the connection shaft.

8. The shift control device of claim 7, wherein the protrusion selectively rotates the hinge shaft forward or rearward of the vehicle according to a rotating direction of the actuating gear engaged with the driven gear train when the actuating dial is rotated.

9. The shift control device of claim 7, wherein the connection shaft is formed perpendicular to the hinge shaft, and is moved forward or rearward of the vehicle according to a rotating direction of the hinge shaft.

10. The shift control device of claim 7, wherein the second cover housing is detachably assembled with the upper portion of the base housing through an assembly fastener.

11. The shift control device of claim 1, wherein the at least one PCB are provided at a first side and a second side inside the internal space in a width direction of the vehicle, respectively.
